(19) United States
(12) Patent Application Publication
(10) Pub. No.: US 2020/0363006 A1
(43) Pub. Date: Nov. 19, 2020

(54) MOTION BASE

(71) Applicant: Wataru Wakita, Hiroshima-shi, Hiroshima (JP)

(72) Inventor: Wataru Wakita, Hiroshima-shi, Hiroshima (JP)

(21) Appl. No.: 16/637,158

(22) PCT Filed: Aug. 8, 2018
(86) PCT No.: PCT/JP2018/029724

§ 371 Date: Feb. 6, 2020

(30) Foreign Application Priority Data
Aug. 9, 2017 (JP) 2017-153949

(51) Int. Cl. F16M 11/20; A47C 7/00; A47C 7/56

(52) U.S. Cl. CPC F16M 11/2078; A47C 7/563; A47C 7/002

(57) ABSTRACT

A motion base (100) includes: a first installation base (1a); a first movable base (2a) on which a placement subject is to be placed and that is disposed on the first installation base (1a); at least two first actuators (3a) each of which is extendable and contractible; first connecting portions (1a) connecting the first actuators (3a) to the first movable base (2a); second connecting portions (4b) connecting the first actuators (3a) to the first installation base (1a); and a spherical surface body (5) that has a spherical surface-shaped portion (15), is disposed on the first installation base (1a), and supports the first movable base (2a) such that an attitude of the first movable base (2a) can be changed relative to the first installation base (1a) by sliding the spherical surface-shaped portion (15).

### TECHNICAL FIELD

The present disclosure relates to a motion base for shaking a placement subject such as a person or a seat. More specifically, the present disclosure relates to a motion base in which (i) a first installation base and a first movable base on which the placement subject is to be placed are connected to each other by a first actuator able to extend and contract and (ii) a spherical surface body constituting a perfect sphere or a portion of the sphere is interposed between the first installation base and the first movable base, thereby enabling a reduction in an output of the first actuator able to extend and contract when the first movable base is shaken relative to the first installation base.

### BACKGROUND ART

Conventionally offered motion bases for shaking a placement subject such as a person or a seat include a Stewart platform in which six extendable and contractible actuators are connected to three portions of an installation base and three portions of a movable base in the shape of the letter “V”. In such a motion base, the actuators are turnably connected to the installation base and/or the movable base (that is, such that, in the portions where the actuators are coupled with each of the above-described bases, each of the actuators has a rotational degree of freedom relative to its connecting partner). This motion base enables achievement of (i) three-degrees-of-freedom translational motions in the forward-backward, vertical, and leftward-rightward directions of the movable base and (ii) three-degrees-of-freedom turning motions around a roll axis, a pitch axis and a yaw axis.

However, this motion base requires complicated coordinate transformation processing for control of extension or contraction of the actuator. Additionally, if the center of gravity is located at the upper portion of the movable base on which the placement subject is placed, a moment increases due to a turning motion, and thus this motion base requires a high-power actuator that can withstand the increasing moment.

Other conventionally-offered configurations of such a motion base include a configuration in which (i) the installation base and the movable base are vertically connected to each other by an extendable and contractible actuator and (ii) their connecting portions are fitted with the connecting portions having a rotational degree of freedom, thereby enabling achievement of one-degree-of-freedom translational motion in the vertical direction and two-degrees-of-freedom turning motions around the roll axis and the pitch axis. As in the Stewart platform, in a motion base having such a configuration, when the center of gravity is located at the upper portion of the movable base on which the placement subject is placed, a moment increases due to a turning motion, and thus the motion base having such a configuration also requires a high-power actuator that can withstand the increasing moment.

Additionally, the other conventionally-offered configurations of such a motion base also include a configuration in which an extendable and contractible column is interposed between the installation base and the movable base of the Stewart platform, thereby dissipating, to the installation base, most of the weight received by the movable base (refer to Patent Literature 1). In this motion base, a load applied during a forward-backward or leftward-rightward translational motion is reduced by a reaction force caused by connecting the column and the installation base via an elastic member such as a rubber cord. In the motion base having such a configuration, the column and the movable base are connected with each other by a fastening rope, thereby enabling, by the reaction force, a reduction of the moment that increases during the turning motion around the roll axis, the pitch axis, and the yaw axis.

Other literature also disclose that a motion base can reduce a moment that increases during a turning motion (refer to Patent Literature 2 and 3).

### CITATION LIST

### Patent Literature

Patent Literature 1: National Patent Publication No. 2016-533534

Patent Literature 2: Japanese Patent No. 3795838

Patent Literature 3: Japanese Patent No. 4813038

### SUMMARY OF INVENTION

### Technical Problem

The motion base disclosed in a document represented by Patent Literature 1 described above requires use of an elastic member such as a coil spring or a fastening rope in order to reduce the moment that increases during the turning motion. Additionally, if the placement subject is light, the movable base is hard to rotate unless the reaction force is adjusted in accordance with the weight of the placement subject or the position of the center of gravity of the placement subject. As a result, the motion base requires dynamic control of a position at which the members that are involved in generation of the reaction force are connected to one another. The motion base as described above has a shortcoming in that a compact design configuration cannot be achieved because the motion base requires a specific member for reducing the moment or control for reducing the moment in order to reduce the moment during the turning motion of the movable base.

The present disclosure is developed in consideration of the aforementioned circumstances, and an objective of the present disclosure is to provide a motion base (i) having a compact device configuration and (ii) enabling a reduction in a moment that increases during a turning motion of a movable base.

### Solution to Problem

In order to attain the aforementioned objective, a motion base according to the present disclosure includes (i) a first installation base, (ii) a first movable base on which a placement subject is to be placed, the first movable base being disposed on the first installation base, (iii) at least two first actuators each of which is extendable and contractible, (iv) first connecting portions connecting the first actuators to the first movable base, (v) second connecting portions connecting the first actuators to the first installation base, and (vi) a spherical surface body that has a spherical surface-shaped portion, is disposed on the first installation base, and supports the first movable base such that an attitude of the first movable base can be changed relative to the first installation base by sliding the spherical surface-shaped portion, wherein each of the first actuators extends and contracts between one of the first connecting portions and one of the second connecting portions and changes the attitude of the first movable base relative to the first installation base.

In this case, the first connecting portions may connect the first actuators to the first movable base such that the first actuators are able to be turned relative to the first movable base.

Also, the second connecting portions may connect the first actuators to the first installation base such that the first actuators are able to be turned relative to the first installation base.

The spherical surface body may be fixed to the first movable base with the spherical surface-shaped portion facing downward.

A two-rotational-degrees-of-freedom shake of the first movable base relative to the first installation around the roll axis and pitch axis may be achieved by extending or contracting the first actuators.

The motion base may comprise a second installation base comprising a first turntable and a second actuator to turn the first turntable, and the first installation base may be disposed on the first turntable.

A shake of the first movable base around the yaw axis may be achieved by turning the first turntable by the second actuator.

The motion base may comprise a second movable base comprising a second turntable and a third actuator to turn the second turntable, and the second movable base may be disposed on the first movable base.

A shake of the second movable base around the yaw axis may be achieved by turning the second turntable by the third actuator.

### Advantageous Effects of Invention

In the motion base according to the present disclosure, the spherical surface body is interposed between the first movable base and the first installation base, and the first movable base and the first installation base are connected to each other by at least two first actuators that are extendable and contractible. Most of the weight of a load received by the first movable base is supported by the first installation base through the spherical surface body.

Such a configuration of the motion base eliminates (i) the need for a member for generating a reaction force, such as an elastic member, a fastening rope or the like, and (ii) the need to dynamically control the positions of the connection of the members involved in the occurrence of the reaction force in accordance with the weight of the load, a position of the center of gravity of the load, and the like. As a result, the motion base of the present disclosure, with a compact device configuration, can reduce a moment that increases during the turning motion of the movable base.

### BRIEF DESCRIPTION OF DRAWINGS

FIG. 1 is a view illustrating an exterior of a motion base according to Embodiment 1 of the present disclosure and a basic configuration of the motion base;

FIG. 2A is a view illustrating a (first) modified example of the configuration of the motion base according to Embodiment 1 of the present disclosure;

FIG. 2B is a view illustrating a (second) modified example of the configuration of the motion base according to Embodiment 1 of the present disclosure;

FIG. 2C is a view illustrating a (third) modified example of the configuration of the motion base according to Embodiment 1 of the present disclosure;

FIG. 3A is a view illustrating a state of a user sitting on a seat that is attached to the motion base according to Embodiment 1 of the present disclosure that is in neutral state;

FIG. 3B is a view illustrating a state in which the motion base illustrated in FIG. 3A is turned around a pitch axis;

FIG. 3C is a view illustrating a state in which the motion base illustrated in FIG. 3A is turned around a roll axis;

FIG. 4A is a view illustrating a (first) example of a configuration of a second installation base for achieving a turn of a motion base around a yaw axis in Embodiment 2 of the present disclosure;

FIG. 4B is a view illustrating a (second) example of the configuration of the second installation base for achieving the turn of the motion base around the yaw axis in Embodiment 2 of the present disclosure;

FIG. 5 is a schematic view illustrating a modified example of the configuration of the motion base according to Embodiment 2 of the present disclosure;

FIG. 6A is a graph illustrating a relationship between (i) a length of a first actuator that is extended or contracted and (ii) an actual angle when a first movable base is shaken around the pitch axis in the motion base according to Embodiment 2 of the present disclosure;

FIG. 6B is a graph illustrating a relationship between (i) a length of the first actuator that is extended or contracted and (ii) an actual angle when the first movable base is shaken in the roll direction in the motion base according to Embodiment 2 of the present disclosure;

FIG. 7A is a graph illustrating values detected by a load sensor when, in the motion base according to Embodiment 1 of the present disclosure, (i) a spherical surface body having a radius of 10 cm is attached to a first movable base with the spherical surface body facing downward, (ii) the load sensor is attached to a turnable connection portion between a first installation base and the first actuator, and (iii) the first movable base is shaken in a pitch direction; and

FIG. 7B is a graph illustrating values detected by the load sensor when, in the motion base according to Embodiment 1 of the present disclosure, (i) the spherical surface body having a radius of 20 cm is attached to the first movable base with the spherical surface body facing downward, (ii) the load sensor is attached to the turnable connection portion between the first installation base and the first actuator, and (iii) the first movable base is shaken in the pitch direction.

### DESCRIPTION OF EMBODIMENTS

Embodiments of the present disclosure are described below in detail with reference to the drawings. In the drawings, components that are the same or equivalent are assigned the same reference signs.

### Embodiment 1

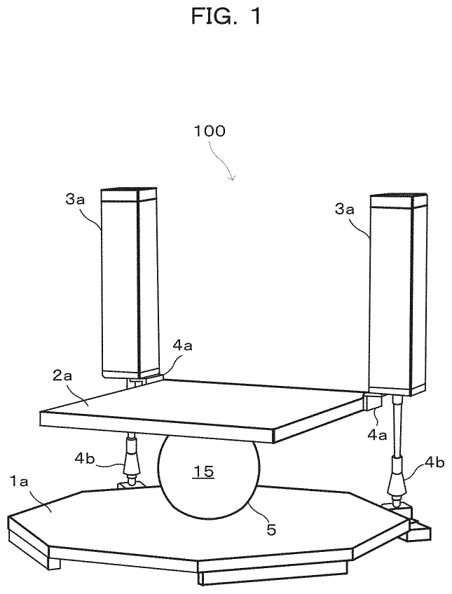

First, Embodiment 1 of the present disclosure is described. As in the appearance illustrated in FIG. 1, as a basic configuration of a motion base 100 according to Embodiment 1 of the present disclosure, the motion base 100 includes a first installation base 1a, a first movable base 2a, and at least two first actuators 3a, at least two first connecting portions 4a, at least two second connecting portions 4b, and a spherical surface body 5.

The first installation base 1a is a plate-like member installed on a floor surface or the like of a building which is not illustrated in the drawings. Although FIG. 1 illustrates the first installation base 1a as being octagonal, the first installation base of the present disclosure is not limited to such a shape.

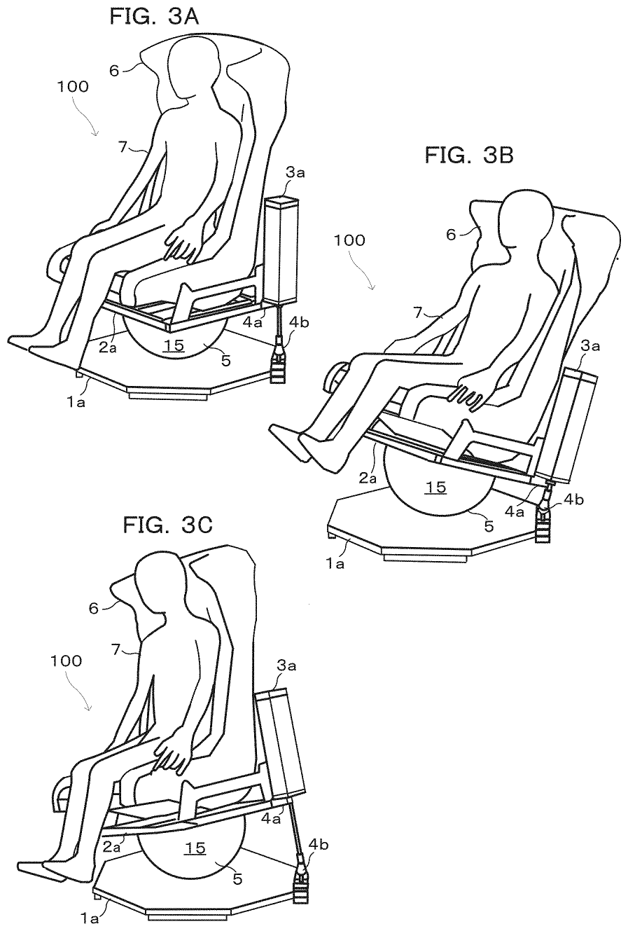

The first movable base 2a is a plate-like member arranged above the first installation base 1a. A placement subject such as a person or a seat is loaded on the first movable base 2a (refer to FIG. 3A and the like). Although FIG. 1 illustrates the first movable base 2a as being rectangular, the first movable base of the present disclosure is not limited to such a shape.

The first actuators 3a are actuators that can be extended and contracted in the longitudinal direction by driving of a control device which is not illustrated in the drawings. Actuators such as electric, hydraulic or pneumatic cylinders can be used as the first actuators 3a.

The first connecting portions 4a connect the first actuators 3a to the first movable base 2a. In the present embodiment, the first connecting portions 4a are L-shaped members. The positional relationship between the first actuators 3a and the first movable base 2a that are connected to each other by the first connecting portions 4a is unchanging.

The second connecting portions 4b connect the first actuators 3a to the first installation base 1a. Specifically, the second connecting portions 4b connect the first actuators 3a to the first installation base 1a such that the first actuators 3a can turn relative to the first installation base 1a (that is, such that the first actuators 3a have a rotational degree of freedom).

For example, regarding the second connecting portions 4b, the second connecting portions 4b can have a configuration in which ends of the first actuators 3a are formed into a spherical shape, the spherical ends are fitted to the second connecting portions 4b, and the spherical ends of the first actuators 3a slide within the corresponding second connecting portions 4b. Such a configuration enables the first actuators 3a to be turnably connected to the second connecting portions 4b. In this manner, even if the first movable base 2a turns around the roll axis and the pitch axis relative to the first installation base 1a, the first actuators 3a can be turned relative to the first installation base 1a in the second connecting portions 4b in accordance with the turn of the first movable base 2a.

As described above, the first actuators 3a extend and contract between the first connecting portions 4a and the second connecting portions 4b, thereby enabling a change in the attitude of the first movable base 2a relative to the first installation base 1a.

The spherical surface body 5 is disposed between the first installation base 1a and the first movable base 2a. More specifically, the spherical surface body 5 has a spherical surface-shaped portion 15. The spherical surface body 5 is disposed on the first installation base 1a. The spherical surface body 5 supports the first movable base 2a such that the attitude of the first movable base 2a relative to the first installation base 1a can be changed by sliding the spherical surface-shaped portion 15.

As described above, the first actuators 3a are connected to the first movable base 2a via the first connecting portions 4a and are connected to the first installation base 1a via the second connecting portions 4b. Each of the two first actuators 3a are extended or contracted, thereby enabling a change in the relative attitude of the first movable base 2a relative to the first installation base 1a.

For example, if the two first actuators 3a are extended or contracted such that an amount by which one of the two first actuators 3a is extended or contacted is different from an amount by which the other one of the two first actuators 3a is extended or contacted, the first movable base 2a can be turned around the roll axis relative to the first installation base 1a. Furthermore, if the two first actuators 3a are extended or contracted such that an amount by which one of the two first actuators 3a is extended or contacted is equal to an amount by which the other one of the two first actuators 3a is extended or contacted, the first movable base 2a can be turned around the pitch axis relative to the first installation base 1a.

Thus, a shake of the first movable base 2a relative to the first installation base 1a by two-degrees-of-freedom turns around the roll axis and pitch axis is achieved by expanding or contracting the first actuator 3a.

In the motion base 100 according to Embodiment 1, the spherical surface body 5 may be fixed to at least one of the first installation base 1a or the first movable base 2a for the purpose of stabilization.

Also, in order to facilitate a rolling motion of the spherical surface body 5 interposed between the first installation base 1a and the first movable base 2a, a wheel for receiving the spherical surface may be attached to the first installation base 1a and the first movable base 2a.

Additionally, the first installation base 1a or the first movable base 2a may be provided with a recess that comes into contact with the spherical surface body 5 and a lubricant may be applied to the surface thereof. Alternatively, the first installation base 1a or the first movable base 2a may be made of a slippery material such as Teflon (registered trademark).

In the motion base 100 illustrated in FIG. 1, the second connecting portions 4b connect the first actuator 3a to the first installation base 1a such that the first actuators 3a are able to be turned relative to the first installation base 1a (that is, the first actuators 3a have a rotational degree of freedom). However, the present disclosure is not limited to such a configuration. The first connecting portions 4a may connect the first actuator 3a to the first movable base 2a such that the first actuators 3a are able to be turned relative to the first movable base 2a.

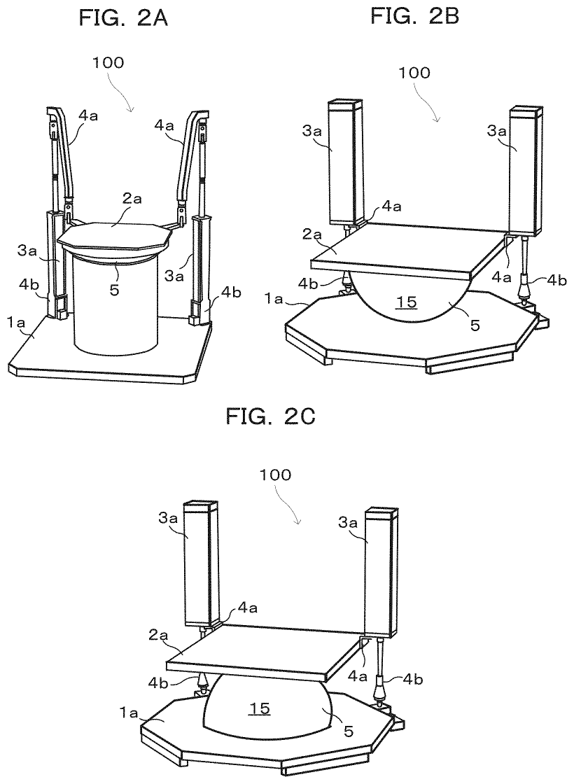

FIGS. 2A to 2C are perspective views illustrating modified examples of the configuration of the motion base 100 of FIG. 1. FIG. 2A illustrates the modified example of the configuration of the motion base 100, which is an ideal configuration example. In the motion base 100 illustrated in FIG. 2A, the two extendable and contractible first actuators 3a are fixed with the first actuators 3a facing upward, and the first connecting portions 4a connect the upper ends of the first actuators 3a to the first movable base 2a such that the first movable base 2a is suspended by the upper ends of the first actuators 3a. Additionally, in this motion base 100, the spherical surface body 5 is fixed to the first movable base 2a.

Also, in the motion base 100 illustrated in FIG. 2B, the first actuators 3a illustrated in FIG. 2A are fixed to the first movable base 2a with the first actuators 3a facing downward. Also, in the motion base 100 illustrated in FIG. 2C, the spherical surface body 5 is fixed to the first installation base 1a.

As illustrated in FIG. 2C, when the spherical surface body 5 is fixed to the first installation base 1a such that the spherical surface-shaped portion 15 faces upward, the position of the center of gravity becomes higher as compared with a case in which the spherical surface body 5 is fixed to the first movable base 2a, thereby causing an increase in moment. For this reason, as illustrated in FIG. 2B, the spherical surface body 5 is preferentially fixed such that the spherical surface-shaped portion 15 faces downward, that is, faces the first installation base 1a. That is, the spherical surface body 5 is preferentially fixed to the first movable base 2a with the spherical surface-shaped portion 15 facing downward.

In this case, if the spherical surface body 5 is heavy, the position of the center of gravity of the placement subject becomes low, thereby suppressing an increase in moment. Accordingly, the spherical surface body 5 is preferably heavy. Additionally, since a small-sized the spherical surface body 5 causes an increase in moment, the spherical surface body 5 is preferentially large.

In the motion bases 100 illustrated in FIG. 1 and FIGS. 2A to 2C, the first connecting portions 4a connect the first actuators 3a to the first movable base 2a such that the first actuators 3a are able to be turned relative to the first movable base 2a, or the second connecting portions 4b connect the first actuators 3a to the first installation base 1a such that the first actuators 3a are able to be turned relative to the first installation base 1a. However, the present disclosure is not limited to such configurations. Both the first connecting portions 4a and the second connecting portions 4b may connect the first actuators 3a to the first movable base 2a such that the first actuators 3a can be turned relative to the first movable base 2a and may connect the first actuators 3a to the first installation base 1a such that the actuator 3a can be turned relative to the first installation base 1a.

Also, in order to (i) connect the first connecting portions 4a to the first actuators 3a and the first movable base 2a such that the first actuators 3a can be turned relative to the first movable base 2a or (ii) connect the second connecting portions 4b to the first actuators 3a and the first installation base 1a such that the first actuators 3a can be turned relative to the first installation base 1a, a turnable element may be provided at the center of each of the first connecting portion 4a and the second connecting portion 4b. Alternatively, the turnable element may be provided on one end or both ends of each of the first connecting portion 4a and the second connecting portion 4b.

FIGS. 3A to 3C illustrate a state of a user 7 sitting on a seat 6 that is attached to the motion base 100 of FIG. 2B. FIG. 3A illustrates that the motion base 100 is in the neutral state. Also, FIG. 3B illustrates a state in which the motion base 100 is turned around the pitch axis. Additionally, FIG. 3C illustrates a state in which the motion base 100 is turned around the roll axis.

For example, when both the two first actuators 3a are extended or contracted by the same amount and in the same direction, the first movable base 2a is turned around the pitch axis as illustrated in FIG. 3B. Also, when the two first actuators 3a are extended or contracted by the same amount such that a direction in which one of the first actuators 3a is extended or contracted is different from a direction in which the other one of the first actuators 3a is extended or contracted, the first movable base 2a is turned around the roll axis as illustrated in FIG. 3C. Additionally, when the two first actuators 3a are expanded and contracted such that an amount by which one of the first actuators 3a is extended or contracted is different from an amount by which the other one of the first actuators 3a is extended or contracted, the first movable base 2a is turned around the roll axis and the pitch axis.

In this case, the contact point between the spherical surface body 5 and the first installation base 1a is shifted by a predetermined amount in accordance with a rotation angle around the pitch axis and a rotation angle around the roll axis, and the relative positional relationship between the first installation base 1a and the first movable base 2a is maintained.

In the motion base 100 according to Embodiment 1, the spherical surface body 5 is disposed between the first installation base 1a and the first movable base 2a, and at least two first actuators 3a that can extend and contract between the first installation base 1a and the first movable base 2a connect the first installation base 1a to the first movable base 2a.

Additionally, in this motion base 100, the first connecting portions 4a are connected to at least either the extendable and contractible first actuators 3a or the first installation base 1a such that the first connecting portions 4a have a rotational degree of freedom, and the second connecting portion 4b is connected to at least either the extendable and contractible first actuators 3a or the first movable base 2a such that the second connecting portions 4b have a rotational degree of freedom. Such a configuration enables an achievement of a compact and low-cost motion base without complicated control of shaking caused by the two-degrees-of-freedom turns around the roll axis and the pitch axis as loads applied to the extendable and contractible first actuators 3a are reduced.

That is, the larger the spherical surface body 5, the larger the contact area with the first installation base 1a becomes, and the first installation base 1a supports most of a load weight received by the first movable base 2a via the spherical surface body 5, even if the first movable base 2a is turned. As a result, the moment is unlikely to increase. Accordingly, the output of the first actuator 3a can be significantly reduced. Also, when the spherical surface body 5 is attached to the first movable base 2a, the heavier the spherical surface body 5, the lower the position of the center of gravity of the placement subject becomes, and thus a restoring force causing the first movable base to return to the original attitude acts on the first movable base even if the first movable base 2a is shaken, thereby making occurrence of an increase in the moment difficult, and thus the output of the first actuator 3a can be significantly reduced.

The spherical surface body 5 interposed between the first movable base 2a and the first installation base 1a does not have to be made as a solid component. The spherical surface body 5 may be made a hollow spherical component as long as the spherical surface body 5 has sufficient strength to support the weight of the first movable base 2a and the weight of the user 7 on the first movable base 2a. Also, regardless of whether the spherical surface body is a solid component or a hollow component, components that can be used as the spherical surface body 5 include, for example, a component consisting of only a rib, a component that is polygonal in shape and to which a wheel is attached, and a component that forms a spherical shape as a whole even if the shape of the component is not a perfect spherical shape.

### Embodiment 2

Next, Embodiment 2 of the present disclosure is described. A motion base 101 according to Embodiment 2 differs from the motion base 100 according to Embodiment 1 in that the motion base 101 according to Embodiment 2 includes a second installation base 1b.

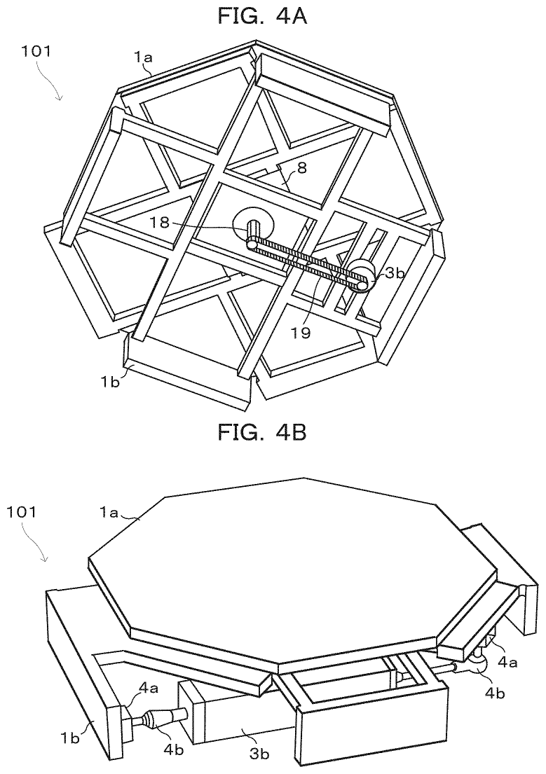

As illustrated in FIG. 4A, the first installation base 1a is placed on the second installation base 1b. The second installation base 1b includes a turntable 8 and a second actuator 3b, as illustrated in FIG. 4A. The second actuator 3b is connected to a turn shaft 18 of the turntable 8 via an endless belt 19 and drives the turntable 8 to turn the turntable 8.

In the motion base 101 according to the present embodiment, a servomotor is preferentially used as the second actuator 3b in order to enable the turntable to be endlessly rotatable around the yaw axis.

The first installation base 1a is placed on the turntable 8. Accordingly, a shake of the first installation base 1a around the yaw axis can be achieved by turning the turn shaft 18.

Also, FIG. 4B illustrates the structure in which an extendable and contractible actuator (an actuator having the same structure as the first actuators 3a) is used as the second actuator 3b. As illustrated in FIG. 4B, even if the extendable and contractible actuator is used as the second actuator 3b and the turntable 8 and the second installation base 1b are connected to each other via the first connecting portions 4a and the second connecting portions 4b, the turntable 8 and the first installation base 1a placed on the turntable 8 can be shaken relative to the second installation base 1b by extending or contracting the second actuator 3b.

As described above, the motion base 101 according to Embodiment 2 includes the second installation base 1b that includes the turntable 8 and the second actuator 3b that can turn the turntable 8. By placing the first installation base 1a on the turntable 8, turning of the first movable base 2a around not only the roll axis and the pitch axis but also around the yaw axis can be achieved.

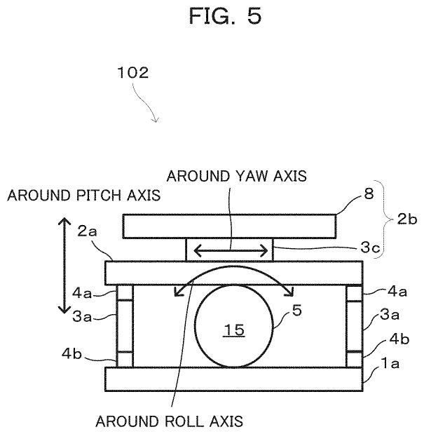

Also, as illustrated in FIG. 5, the motion base 102 including the second movable base 2b may be used. The second movable base 2b includes the turntable 8 and the third actuator 3c that can turn the turntable 8. In this case, the second movable base 2b is placed on the first movable base 2a. The second movable base 2b can be turned not only around the roll axis and pitch axis but also around the yaw axis of the turntable 8 by turning the turntable 8 by the third actuator 3c, thereby enabling an achievement of a three-degrees-of-freedom shake of the turntable 8.

In order to show the feasibility of the present disclosure, the motion base 100 was produced experimentally, and a specific experiment was performed on the experimentally-produced motion base 100. For the experimentally-produced motion base 100, SCN6-040-150 manufactured by the Dyadic Systems Co., Ltd is used as the first actuators 3a that are extendable and contractible, and link ball screws are used as the second connecting portions 4b having a rotational degree of freedom.

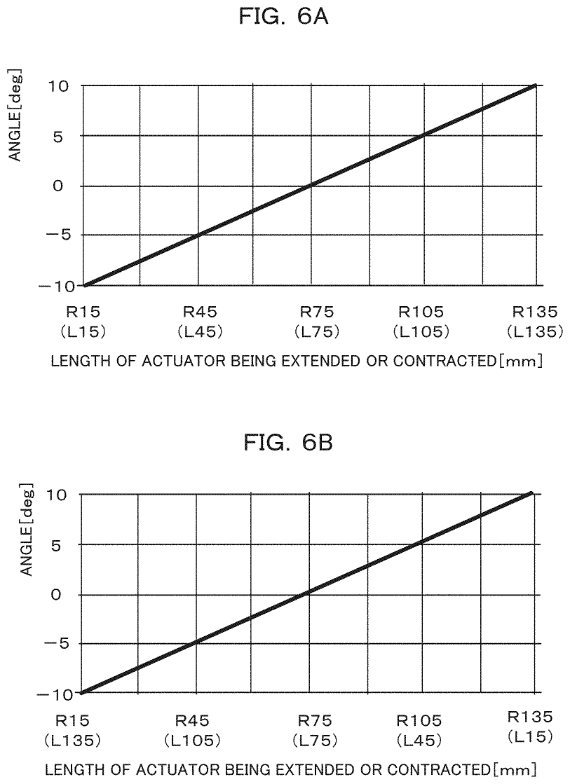

FIGS. 6A and 6B illustrate the relationship between (i) a length of the first actuator 3a that is extended or contracted and (ii) an angle of the first movable base 2a when the first movable base 2a of the experimentally-produced motion base 100 is turned.

FIG. 6A illustrates the relationship in a case in which the first movable base 2a is turned around the pitch axis. As illustrated in FIG. 6A, when lengths of the two first actuators 3a that are extended or contracted are in the range of 15 mm to 135 mm, an angle by which the first movable base 2a is turned by an angle of −10 degrees to 10 degrees.

FIG. 6B illustrates the relationship in a case in which the first movable base 2a is turned around the roll axis. As illustrated in FIG. 6B, when a length of one of the two first actuators 3a that is extended or contracted is in the range of 15 to 135 mm (and a length of the other one of the two first actuators 3a that is extended or contracted is in the range of 135 to 15 mm), the first movable base 2a is turned by an angle of −10 degrees to 10 degrees.

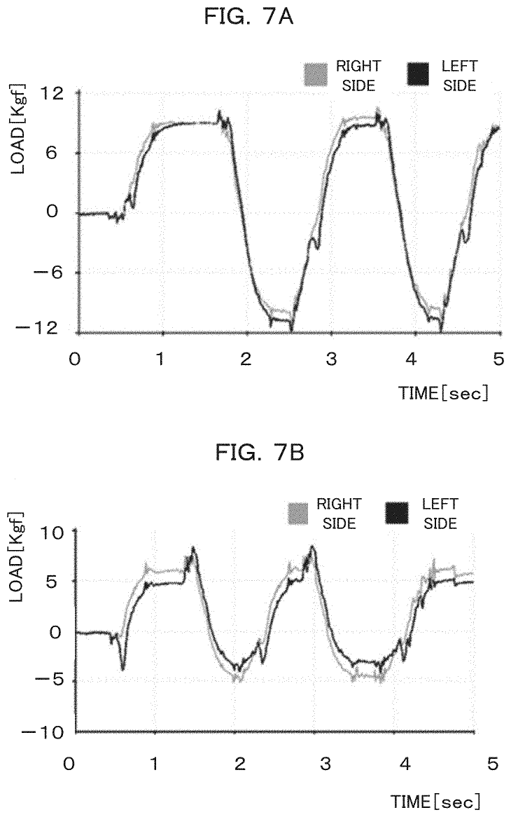

FIGS. 7A and 7B illustrate values detected by a load sensor when (i) the spherical surface body 5 is attached to the first movable base 2a of the motion base 100 according to Embodiment 1 of the present disclosure with the spherical surface body 5 facing downward, (ii) the load sensor is attached to the lower portion of the turnable connection portion between the first installation base 1a and each of the first actuators 3a, and (iii) the first movable base 2a is shaken in the pitch direction.

FIG. 7A illustrates the values detected by the load sensor when the radius of the spherical surface body 5 is 10 cm. Additionally, FIG. 7B illustrates the values detected by the load sensor when the radius of the spherical surface body 5 is 20 cm. When FIG. 7A is compared with FIG. 7B, FIGS. 7A and 7B show that the larger the radius of the spherical surface body 5, the less the loads applied to the first connecting portions 4a and the second connecting portions 4b become, and thus the use of a large radius of the spherical surface body 5 enables a reduction in the loads applied to the first actuators 3a.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-153949, filed on Aug. 9, 2017, the entire disclosure of which is incorporated by reference herein.

### INDUSTRIAL APPLICABILITY

When a seat is provided on the first movable base, the motion bases according to the present disclosure are applicable to a driving simulator, a game or the like that enables a person to be subjected to inertial force and somatic sensation with the person sitting on the seat. Also, the motion bases according to the present disclosure can be used as a walking sensation presentation apparatus such as a slope in a state in which a person stands on the first movable base and gets on each of the motion bases. Also, the motion bases according to the present disclosure are applicable to a simulator or a game of skiing, skateboarding, and the like by providing the first movable base with a board or the like.

### REFERENCE SIGNS LIST

1a First installation base
1b Second installation base
2a First movable base
2b Second movable base
3a First actuator
3b Second actuator
3c Third actuator
4a First connecting portion
4b Second connecting portion
5 Spherical surface body
6 Seat
7 User
8 Turntable
15 Spherical surface-shaped portion
18 Turn shaft
19 Endless belt
100 Motion base
101 Motion base
102 Motion base

1. A motion base comprising:
a first installation base;
a first movable base on which a placement subject is to be placed, the first movable base being disposed on the first installation base;
two first actuators each of which is extendable and contractible;
first connecting portions connecting the first actuators to the first movable base;
second connecting portions connecting the first actuators to the first installation base; and
a spherical surface body that has a spherical surface-shaped portion, is disposed on the first installation base, and supports the first movable base such that an attitude of the first movable base can be changed relative to the first installation base by sliding the spherical surface-shaped portion with the spherical surface-shaped portion touching only one point on the first installation base, wherein
when the first connecting portions connect the first actuators to the first movable base such that the first actuators are turned relative to the first movable base, the second connecting portions connect the first actuators to the first installation base such that a relatively positional relationship between each of the first actuators and the first installation base is unchanging,
when the second connecting portions connect the first actuators to the first installation base such that the first actuators are turned relative to the first installation base, the first connecting portions connect the first actuators to the first movable base such that a relatively positional relationship between each of the first actuators and the first movable base is unchanging,
each of the first actuators extends and contracts between one of the first connecting portions and one of the second connecting portions and changes the attitude of the first movable base relative to the first installation base with the first movable base supported by the spherical surface body and the first actuators in a three-point support manner.

2. (canceled)

3. (canceled)

4. The motion base according to claim 1, wherein the spherical surface body is fixed to the first movable base with the spherical surface-shaped portion facing downward.

5. The motion base according to claim 1, wherein a two-rotational-degrees-of-freedom shake of the first movable base relative to the first installation base around the roll axis and pitch axis is achieved by extending or contracting the first actuators.

6. The motion base according to claim 1, wherein
the motion base further comprises a second installation base comprising a first turntable and a second actuator to turn the first turntable, and
the first installation base is disposed on the first turntable.

7. The motion base according to claim 6, wherein a shake of the first movable base around the yaw axis is achieved by turning the first turntable by the second actuator.

8. The motion base according to claim 1, wherein
the motion base comprises a second movable base comprising a second turntable and a third actuator to turn the second turntable, and
the second movable base is disposed on the first movable base.

9. The motion base according to claim 8, wherein a shake of the second movable base around the yaw axis is achieved by turning the second turntable by the third actuator.
